(19) United States
(12) Patent Application Publication
(10) Pub. No.: US 2025/0355788 A1
(43) Pub. Date: Nov. 20, 2025

(54) Test Sequence Generation

(71) Applicant: NATIONAL INSTRUMENTS CORPORATION, Austin, TX (US)

(72) Inventors: Stephen Thung, Norman, OK (US); Sebastien Savard-Rosas, Austin, TX (US); Andrew Philip Dove, Austin, TX (US)

(21) Appl. No.: 19/210,768

(22) Filed: May 16, 2025

Related U.S. Application Data
(60) Provisional application No. 63/649,723, filed on May 20, 2024.

(51) Int. Cl. G06F 11/3668; G06F 16/3329

(52) U.S. Cl. CPC G06F 11/3684; G06F 11/3688; G06F 16/33295

(57) ABSTRACT

Apparatuses, systems, and methods for test sequence generation to validate a device under test (DUT) can include generating a structured set of test sequence inputs and performing a large language model (LLM) call using the structured set of test sequence inputs. The structured set of test sequence inputs can include parameters associated with the DUT, a list of available tests associated with the DUT, instructions for an LLM to query a database to retrieve test sequence information associated with the DUT, and/or an output structure. The LLM call can be used to generate the test sequence for validating the DUT based on the generated structured set of test sequence inputs.

### PRIORITY CLAIM

This application claims benefit of priority to provisional application No. 63/649,723 entitled “Test Sequence Generation”, filed on May 20, 2024, whose disclosure is hereby incorporated by reference in its entirety as though fully and completely set forth herein.

### TECHNICAL FIELD

The invention relates to test process development, and more particularly to apparatuses, systems, and methods for generative Artificial Intelligence (AI) assisted test process development, e.g., using a generative AI based system to design a test sequence from documentation associated with a device under test (DUT).

### DESCRIPTION OF THE RELATED ART

Currently, there are a variety of tools to support a test engineer in test process development when given a specification of a DUT. For example, there are tools to aid a test engineer in the front-end of life cycle of a test process, e.g., such as tools to match tests to instruments. Further, there are tools to aid a test engineer in the back end of the life cycle of the test process, e.g., such as tools that provide measurement abstraction. In addition, there are various tools that provide high-level test support as well as tools that can generate test sequences based on detailed inputs from the test engineer.

However, a test engineer may need to work/interact with many, disparate software systems to leverage these various tools to develop the test process for the DUT. For example, in various aspects of development of the test process, a test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each role/tool may require its own expertise and resource, leading to high overhead costs in time, training, and expertise develop. These high overhead costs may then extend time to market for particular products. Therefore, improvements are desirable.

### SUMMARY

Embodiments described herein relate to computing systems, memory media, and methods for generative Artificial Intelligence (AI) assisted test process development, e.g., using a generative AI based system to design a test sequence from documentation associated with a device under test (DUT).

For example, methods described herein can generate and/or design a test sequence via a large language model (LLM). For example, give various parameters associated with a DUT (e.g., such as operating ranges of the DUT and/or typical specifications of the DUT) and available tests to be performed (e.g., based on available hardware and software), an LLM can be leveraged to generate and/or design the test sequence for the DUT. The operating ranges and/or tests to be performed can be consumed by the LLM from documentation available to the LLM (e.g., via direct user provision and/or via database queries). The documentation can take various formats such as word processing documents, Portable Document Format (PDF) documents, spreadsheets, presentation documents, three-dimensional (3D) models, two-dimensional (2D) models, images, videos, and/or other multimedia recordings, among other file types and/or formats.

In some embodiments, a method for test sequence generation to validate a DUT can include generating a structured set of test sequence inputs and performing an LLM call using the structured set of test sequence inputs. The structured set of test sequence inputs can include parameters associated with the DUT, a list of available tests associated with the DUT, instructions for an LLM to query a database to retrieve test sequence information associated with the DUT, and/or an output structure. The LLM call can be used to generate the test sequence for validating the DUT based on the generated structured set of test sequence inputs.

Note that the techniques described herein can be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting a test generation system, according to some embodiments.

FIG. 4 illustrates a block diagram of an example of a process for test sequence generation to validate a DUT, according to some embodiments.

FIG. 5 illustrates a block diagram of an example of a method for test sequence generation to validate a DUT, according to some embodiments.

While the features described herein can be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
AI: Artificial Intelligence
DUT: Device Under Test
UUT: Unit Under Test
VI: Virtual Instrument
GUI: Graphical User Interface
LLM: Large Language Model
JSON: JavaScript Object Notation

### Terms

The following is a glossary of terms used in this disclosure:

Device Under Test (DUT) or Unit Under Test (UUT)—A physical device or component that is being tested.

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor)—refers to various elements or combinations of elements that are capable of performing a function in a device, such as a user equipment or a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Program—the term “program” is intended to have the full breadth of its ordinary meaning. The term “program” includes 1) a software program which can be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that can be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program can comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, where the plurality of interconnected nodes or icons visually indicate functionality of the program. Can also be referred to as a Virtual Instrument (VI).

Data Flow Graphical Program (or Data Flow Diagram)—A graphical program or diagram comprising a plurality of interconnected nodes, wherein the connections between the nodes indicate that data produced by one node is used by another node. Can also be referred to as a Virtual Instrument (VI).

Graphical User Interface—this term is intended to have the full breadth of its ordinary meaning. The term “graphical user interface” is often abbreviated to “GUI”. A GUI can comprise only one or more input GUI elements, only one or more output GUI elements, or both input and output GUI elements. Can also be referred to as a Virtual Instrument (VI).

The following provides examples of various aspects of GUIs. The following examples and discussion are not intended to limit the ordinary meaning of GUI, but rather provide examples of what the term “graphical user interface” encompasses:

A GUI can comprise a single window, panel, or dialog box having one or more GUI Elements, or can comprise a plurality of individual GUI Elements (or individual windows each having one or more GUI Elements), wherein the individual GUI Elements or windows can optionally be tiled together.

Graphical User Interface Element—an element of a graphical user interface, such as for providing input or displaying output. Exemplary graphical user interface elements include input controls and output indicators.

Input Control—a graphical user interface element for providing user input to a program. Exemplary input controls include buttons, check boxes, input text boxes, knobs, sliders, etc.

Output Indicator—a graphical user interface element for displaying output from a program. Exemplary output indicators include charts, graphs, gauges, output text boxes, numeric displays, etc. An output indicator is sometimes referred to as an “output control”.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately can refer to a value that is within 1 to 10 percent of the exact (or desired) value. It should be noted, however, that the actual threshold value (or tolerance) can be application dependent. For example, in some embodiments, “approximately” can mean within 0.1% of some specified or desired value, while in various other embodiments, the threshold can be, for example, 2%, 3%, 5%, and so forth, as desired or as required by the particular application.

Concurrent—refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

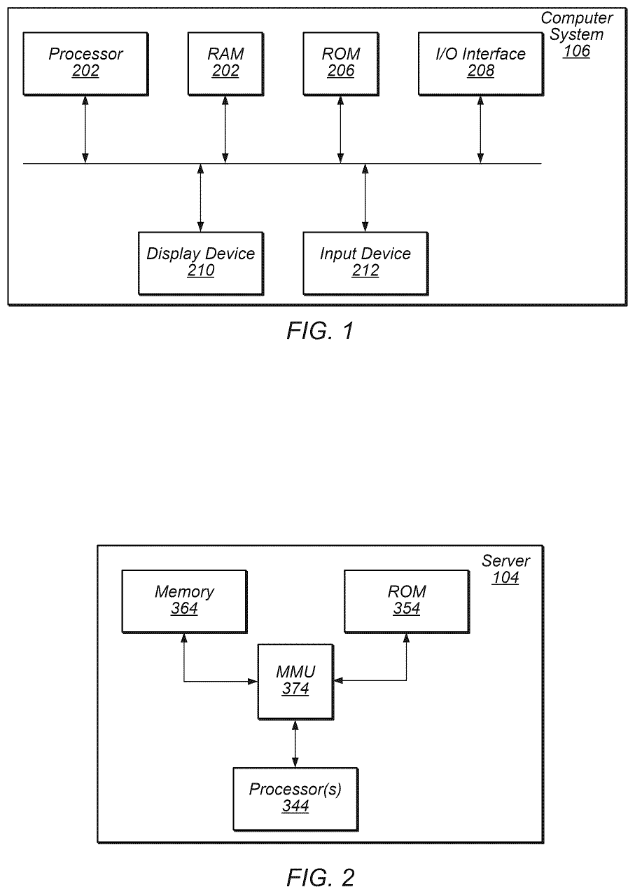

### FIG. 1: Computer System

FIG. 1 illustrates a computer system 106 that can include a processor 202, random access memory (RAM) 204, nonvolatile memory 206, a display device 210, an input device 212 and an I/O interface 208 for coupling to sensors. For example, the computer system 106 can include hardware and software components for implementing or supporting implementation of features described herein. The processor 202 can be configured to implement or support implementation of part or all of the methods described herein, e.g., by executing program instructions stored on a memory medium (e.g., a non-transitory computer-readable memory medium). Alternatively, the processor 202 can be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 can be configured to implement or support implementation of part or all of the features described herein.

In addition, as described herein, processor(s) 202 can be comprised of one or more processing elements. In other words, one or more processing elements can be included in processor(s) 202. Thus, processor(s) 202 can include one or more integrated circuits (ICs) that are configured to perform the functions of processor(s) 202. In addition, each integrated circuit can include circuitry (e.g., first circuitry, second circuitry, etc.) configured to perform the functions of processor(s) 202.

As shown, the computer system 106 can include a processor that is coupled to a random access memory (RAM) and a nonvolatile memory. The computer system 106 can also include user interface elements for receiving user input and a display device for presenting output. For example, the user interface elements can include any of various elements, such as a display (which can be a touchscreen display), a keyboard (which can be a discrete keyboard or can be implemented as part of a touchscreen display), a mouse, a microphone and/or speakers, one or more cameras, one or more buttons, and/or any of various other elements capable of providing information to a user and/or receiving or interpreting user input. The computer system 106 can also include an Input/Output (I/O) interface that can be communicatively coupled (e.g., locally via a system bus, or remotely via a network and/or serial interface) to various hardware elements (e.g., such as FPGAS, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 can include processor(s) 344 which can execute program instructions for the server 104. The processor(s) 344 can also be coupled to memory management unit (MMU) 374, which can be configured to receive addresses from the processor(s) 344 and translate those addresses to locations in memory (e.g., memory 364 and read only memory (ROM) 354) or to other circuits or devices.

The server 104 can be configured to provide a plurality of devices, such as computer system 106, access to a generative AI, e.g., as further described herein.

In some embodiments, the server 104 can access via a radio access network, such as a 5G New Radio (5G NR) radio access network. In some embodiments, the server 104 can be accessed via a local area network (LAN), e.g., via an ethernet and/or Wi-Fi connection.

As described further subsequently herein, the server 104 can include hardware and software components for implementing or supporting implementation of features described herein. The processor 344 of the server 104 can be configured to implement or support implementation of part or all of the methods described herein, e.g., by executing program instructions stored on a memory medium (e.g., a non-transitory computer-readable memory medium). Alternatively, the processor 344 can be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 can be configured to implement or support implementation of part or all of the features described herein.

In addition, as described herein, processor(s) 344 can be comprised of one or more processing elements. In other words, one or more processing elements can be included in processor(s) 344. Thus, processor(s) 344 can include one or more integrated circuits (ICs) that are configured to perform the functions of processor(s) 344. In addition, each integrated circuit can include circuitry (e.g., first circuitry, second circuitry, etc.) configured to perform the functions of processor(s) 344.

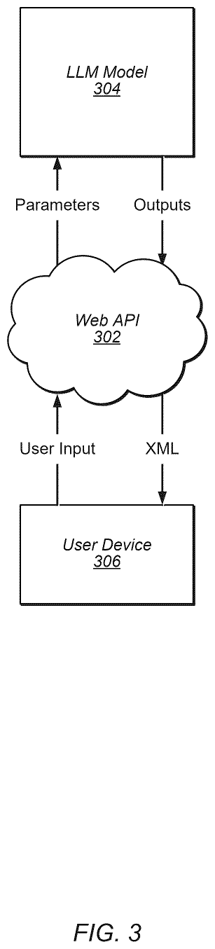

### FIG. 3: Test Generation System

FIG. 3 illustrates an example of a system supporting a test generation system, according to some embodiments. As shown, the system can include a user device 306, e.g., which can be a computer system 106 that provides an interface with a LLM model 304 (e.g., which can be hosted on a server, such as server 104) via a web Application Programming Interface (API) 302. In at least some instances, the LLM model 304 can be one or more models 304 (e.g., one or more artificial intelligence models). The interface can allow the LLM model 304 to interact with (e.g., communicate with) local hardware either on the user device 306 and/or in communication with the user device 306. In addition, the interface can allow the LLM model 304 to interact with local software resources (e.g., such as programming platforms (e.g., LabVIEW™, Python, MeasurementLink, C++, MATLAB™, and so forth). Thus, as shown, a user can interact with the LLM model 304 via web API 302 using the user device 306. The user device 306 can execute one or more software resources as well as host hardware (e.g., such as data acquisition boards, control boards, vision boards, and the like) and/or communicate with remote hardware (e.g., such as data acquisition boards, control boards, vision boards, and the like). The user device 306 can provide user inputs, including information regarding available hardware and/or software resources to the web API 302. The web API 302 can convert the user inputs to LLM model parameters and/or the web API 302 can generate LLM model parameters based on the user inputs. The LLM model parameters can be used by the LLM model 304 to generate and/or produce model outputs that are returned to the web API 302. The web API 302 can then convert the model outputs to Extensible Markup Language (XML) and/or generate XML based on the model outputs. For example, the model outputs can include programming code (e.g., such as graphical programming code) that can be converted (e.g., serialized) to Large Language Model (LLM) optimized XML, JavaScript Object Notation (JSON), and/or a Domain Specific Language (DSL). The XML can then be delivered to the user device 306 as natural language output to an end user. In this manner, the LLM model 304 can interact with the end user to generate and/design a test sequence from documentation associated with a device under test (DUT). Note that the LLM model 304 can be trained to query end users using a plurality of prompts based on user input. Further, the LLM model 304 can be trained to generate graphical programs based on consuming graphical programs, e.g., the LLM model 304 can be trained using thousands of graphical programs. Note further, that aspects of the LLM model 304 can include a user interface executing on the user device 306 as well as background software to discover and maintain hardware information as well as to discover and maintain connections with local applications, the web API 302 to allow the user device 306 to interact with the LLM model 304, and the LLM model 304 that can be executing on a server remote from the user (e.g., the LLM model 304 can be cloud based).

### Test Sequence Generation

Currently, a test engineer may need to work/interact with many, disparate software systems to leverage various tools to develop a test process for a device under test (DUT). Thus, the current test engineer needs to not only understand the DUT to design the test process, but additionally be versed in a vast array of tools. In various aspects of development of the test process, the test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each of these roles/tools require independent expertise and resources, leading to high overhead costs in time, training, and expertise develop. These high overhead costs can then extend time to market for particular products.

In particular, to validate a DUT's performance across its operating ranges, a test engineer may be required to design a test sequence that encodes steps and operations necessary for validation. For example, given the DUT's operating ranges under which it must work and typical specifications defining the DUT's behavior, a test engineer would be required to design the test sequence taking into consideration many factors, such as available hardware and software, testing methodologies, test accuracy, necessary level of confidence in test results, and so forth. Thus, test sequence design can be highly specialized and only performed by test engineers with intimate knowledge of both the DUT and available test infrastructure. Therefore, improvements are desirable.

Embodiments described herein provide systems, methods, and mechanisms to design a test sequence for a device under test (DUT) from documentation associated with the DUT, e.g., via leveraging a large language model (LLM) to generate the test sequence. For example, given operating ranges of the DUT, typical specifications of the DUT, and available tests to be performed, the LLM can generate a test sequence to validate the DUT. The operating ranges and typical specifications of the DUT can be provided as text (e.g., in a table-based format), and/or more generally, any computer readable format such as word processing documents, Portable Document Format (PDF) documents, spreadsheets, presentation documents, three-dimensional (3D) models, two-dimensional (2D) models, images, videos, and/or other multimedia recordings, among other file types and/or formats. In addition, the available tests to be performed (e.g., a list of available tests to be performed) can be provided as text (e.g., as natural language descriptions and/or as code) and/or more generally, via retrieval from a database. Note that the database retrieval may include the LLM collecting/selecting relevant test steps from the database via a retrieval-augmented-generation (RAG) process. The test sequence generation can be based on instructional text created via prompt engineering, e.g., to direct the LLM to generate a test sequence in a pre-defined output structure. a

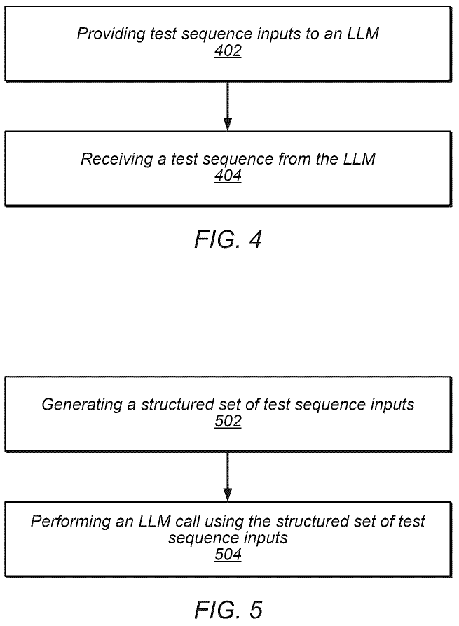

For example, FIG. 4 illustrates a block diagram of an example of a process for test sequence generation to validate a DUT, according to some embodiments. The process shown in FIG. 4 can be used in conjunction with any of the systems, methods, or devices shown in the Figures, among other devices. In various embodiments, some of the process elements shown can be performed concurrently, in a different order than shown, or can be omitted. Additional process elements can also be performed as desired. As shown, this process can operate as follows.

At 402, test sequence inputs can be provided to a large language model (LLM), such as LLM 304. The test sequence inputs can include parameters such as DUT operating ranges, DUT technical specifications, available tests, and/or an output structure for the test sequence. The test sequence inputs can be in the form of a structured prompt, e.g., such as input text.

In some instances, the DUT operating ranges and DUT technical specifications can have a text-based format, such as a table-based format. The table can include fields for various parameters, e.g., such as description (e.g., signal gain, frequency range for signal gain, drain voltage for signal gain, temperature for signal gain, input return loss, and so forth), value, unit or engineering unit (e.g., associated with a value), minimum value (e.g., for a range), maximum value (e.g., for a range), source (e.g., a reference to a document name), page number (e.g., within a document), section (e.g., within a document), and/or version (e.g., of a document), among other fields. Note that in at least some instances, various details of the DUT cannot be captured in a typical specification and/or operating ranges, thus, original specification documents can be included as test sequence inputs. In such instances, the LLM can augment generation of the test sequence by consuming the specification documents, e.g., the specification documents for the DUT can mention features not captured by a range, e.g., such as tests involving the DUT require a set-up and tear-down step. In some instances, the specification documentation can take various formats such as word processing documents, Portable Document Format (PDF) documents, spreadsheets, presentation documents, three-dimensional (3D) models, two-dimensional (2D) models, images, videos, and/or other multimedia recordings, among other file types and/or formats.

In some instances, the list of available tests can be a natural language-based format (e.g., natural language descriptions of test steps) or a code-based format. In some instances, e.g., such as in cases where a large number of test steps are available, it may be infeasible to provide all steps at once to the LLM via inputs, thus relevant test steps can first be collected by a retrieval-augmented-generation (RAG) process by the LLM. In other words, in some instances, the test sequence inputs can include an instruction and/or prompt that instructs the LLM to perform the RAG process to retrieve relevant tests steps.

In some instances, the output structure can be generated via prompting a user to define the test sequence.

In some instances, the test sequence inputs can be combined into a prompt template prior to being provided to the LLM.

At 404, a test sequence can be received from the LLM as output, e.g., based on the test sequence inputs. In some instances, the test sequence can be received as text output from the LLM. In such instances, the text output can be parsed into a structured format, such as JavaScript Object Notation (JSON).

In at least some instances, the list of test steps provided to the LLM may not be sufficient to fully validate the DUT. In such instances, the LLM may be trained to generate additional test steps, e.g., such as nesting an existing step iterating over a first parameter within an iteration over a second parameter.

In some instances, the test steps received from the LLM can be converted to equivalent executable test steps via conversion program.

In some instances, since LLM outputs can be noisy and not guaranteed to match an expected output format, the test sequence received from the LLM can be compared to an expected output format. Further, when the text output by the LLM is determined invalid relative to the expected output format, the test sequence inputs can be re-provided to the LMM in a repetitive manner until the text output by the LMM is determined to be valid relative to the expected output format.

FIG. 5 illustrates a block diagram of an example of a method for test sequence generation to validate a DUT, according to some embodiments. The process shown in FIG. 5 can be used in conjunction with any of the systems, methods, or devices shown in the Figures, among other devices. In various embodiments, some of the process elements shown can be performed concurrently, in a different order than shown, or can be omitted. Additional process elements can also be performed as desired. As shown, this process can operate as follows.

At 502, a structured set of test sequence inputs can be generated. The structured set of test sequence inputs can include parameters associated with the DUT, a list of available tests associated with the DUT, instructions for a large language model (LLM) to query a database to retrieve test sequence information associated with the DUT, and/or an output structure. In some instances, the parameters associated with the DUT can include DUT operating ranges, DUT technical specifications, and/or DUT technical specification documents. In some instances, generation of the structured set of test sequence inputs can include combining one or more inputs associated with the test sequence into an LLM prompt template and generating, based on the LLM prompt template, the structured set of test sequence inputs.

In some instances, the parameters associated with the DUT can use and/or be a text-based format or a code-based format. The text-based format can be a table-based format. The table-based format can be at least two dimensional where a first dimension can include actual values corresponding to one or more fields of a second dimension. In some instances, the first dimension can correspond to rows of a table and the second dimension can correspond to columns of a table. The one or more fields can include one or more of a description field, a value field, an engineering unit field, a minimum value field, a maximum value field, a source field, and/or a source reference field.

In some instances, the DUT technical specification documents can be of various formats. For example, the various formats can include word processing documents, Portable Document Format (PDF) documents, spreadsheet documents, presentation documents, three-dimensional (3D) models associated with the DUT, two-dimensional (2D) models associated with the DUT, images associated with the DUT, videos associated with the DUT, and/or multimedia recordings associated with the DUT. In such instances, an LLM can consume the DUT technical specification documents and extract one or more parameters associated with the DUT.

In some instances, the list of available tests can be in a natural language-based format and/or a code-based format. The natural language-based format can include a natural language description of test steps. The code-based format can include programing code specifying test steps.

In some instances, the instructions for the LLM to query the database can include instructions for the LLM to perform retrieval-augmented-generation (RAG) process to collect test steps from the database.

In some instances, the output structure can be generated based on end user responses to one or more prompts. In such instances, one or more prompts associated with the output structure can be presented to the end user and the output structure can be generated based, at least in part, on one or more inputs collected from the end user. The one or more inputs being associated with the one or more prompts.

At 504, an LLM call, to an LLM such as LLM 304, using the structured set of test sequence inputs can be performed. The LLM call can be used to generate the test sequence for validating the DUT based on the generated structured set of test sequence inputs. In some instances, the generated structured set of test sequence inputs can be uploaded and/or provided to an Application Programming Interface (API) that interfaces with the LLM as part of performing the LLM call to generate the test sequence for validating the DUT. In some instances, the LLM can be located on a cloud-based server.

In some instances, text-based output including and/or indicating the test sequence for validating the DUT based on the generated structured set of test sequence inputs can be received from the LLM. In some instances, the text-based output including and/or indicating the test sequence for validating the DUT can include one or more test steps not included in the test sequence inputs. The one or more test steps not included in the test sequence inputs can include at least one test step independently derived and/or generated by the LLM.

In some instances, the text-based output can be parsed into a structured format. The structured format can be based, at least in part, on JavaScript Object Notation (JSON). Further, in some instances, the structured format can be uploaded and/or provided to an Application Programming Interface (API).

In some instances, the text-based output can be converted to executable steps. In such instances, the conversion can include providing the text-based output to a conversion program and receiving the executable steps as output from the conversion program. In some instances, the executable steps can be uploaded and/or provided to an API.

In some instances, the text-based output including and/or indicating the test sequence for validating the DUT can be compared to an expected output format. Further, validity of the text-based output including and/or indicating the test sequence for validating the DUT can be determined based on the comparison. In some instances, in response to determining that the text-based output including and/or indicating the test sequence for validating the DUT is not valid, one or more additional LLM calls can be performed to generate the test sequence for validating the DUT based on the generated structured set of test sequence inputs.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for test sequence generation to validate a device under test (DUT), comprising:
generating a structured set of test sequence inputs; and
performing, using the structured set of test sequence inputs, a large language model (LLM) call to generate the test sequence for validating the DUT based on the generated structured set of test sequence inputs.

2. The method of claim 1,
wherein the structured set of test sequence inputs includes parameters associated with the DUT.

3. The method of claim 2,
wherein the parameters associated with the DUT include DUT operating ranges.

4. The method of claim 2,
wherein the parameters associated with the DUT include DUT technical specifications.

5. The method of claim 2,
wherein the parameters associated with the DUT use a text-based format.

6. The method of claim 5,
wherein the text-based format comprises a table-based format.

7. The method of claim 6,
wherein the table-based format includes one or more row fields and one or more column fields.

8. The method of claim 2,
wherein the parameters associated with the DUT include DUT technical specification documents.

9. The method of claim 8,
wherein the DUT technical specification documents include at least one of:
word processing documents;
Portable Document Format (PDF) documents;
spreadsheet documents;
presentation documents;
three-dimensional (3D) models associated with the DUT;
two-dimensional (2D) models associated with the DUT;
images associated with the DUT;
videos associated with the DUT; or
multimedia recordings associated with the DUT.

10. The method of claim 1,
wherein performing the LLM call to generate the test sequence for validating the DUT based on the generated structured set of test sequence inputs includes uploading the generated structured set of test sequence inputs to an Application Programming Interface (API) that interfaces with the LLM.

11. A non-transitory computer-readable memory medium storing program instructions which, when executed by a processor, are configured to cause a computing device to perform operations comprising:
generating a structured set of test sequence inputs; and
performing, using the structured set of test sequence inputs, a large language model (LLM) call to generate the test sequence for validating a device under test (DUT) based on the generated structured set of test sequence inputs.

12. The non-transitory computer readable memory medium of claim 11,
wherein the structured set of test sequence inputs includes a list of available tests.

13. The non-transitory computer readable memory medium of claim 12,
wherein the list of available tests comprises a natural language-based format,
wherein the natural language-based format comprises a natural language description of test steps,
wherein the list of available tests comprises a code-based format; and
wherein the code-based format comprises programing code specifying test steps.

14. The non-transitory computer readable memory medium of claim 11,
wherein the structured set of test sequence inputs include instructions for the LLM to perform a retrieval-augmented-generation (RAG) process to collect test steps from a database indicated in the instructions.

15. The non-transitory computer readable memory medium of claim 11,
wherein the structured set of test sequence inputs includes specification of an output structure, and wherein the program instructions are further executable to cause the computing device to perform operations comprising:
presenting one or more prompts associated with the output structure to an end user; and
generating the output structure based, at least in part, on one or more inputs collected from the end user, wherein the one or more inputs are associated with the one or more prompts.

16. The non-transitory computer readable memory medium of claim 11,
wherein to perform operations comprising generating the structured set of test sequence inputs, the program instructions are further executable to cause the computing device to perform operations comprising:
combining one or more inputs associated with the test sequence into a prompt template; and
generating, based on the prompt template, the structured set of test sequence inputs.

17. An apparatus, comprising:
a memory; and
at least one processor in communication with the memory and configured to perform operations comprising:
generating a structured set of test sequence inputs; and
performing, using the structured set of test sequence inputs, a large language model (LLM) call to generate the test sequence for validating a device under test (DUT) based on the generated structured set of test sequence inputs.

18. The apparatus of claim 17,
wherein the at least one processor is further configured to perform operations comprising:
receiving, from the LLM, text-based output comprising the test sequence for validating the DUT based on the generated structured set of test sequence inputs, wherein the text-based output comprising the test sequence for validating the DUT includes one or more test steps not included in the test sequence inputs, and wherein the one or more test steps not included in the test sequence inputs include at least one test step independently derived or generated by the LLM;
parsing the text-based output into a structured format, wherein the structured format comprises JavaScript Object Notation (JSON); and
uploading the structured format to an Application Programming Interface (API).

19. The apparatus of claim 18,
wherein the at least one processor is further configured to perform operations comprising:
converting the text-based output to executable steps, including:
providing the text-based output to a conversion program; and
receiving the executable steps as output from the conversion program.

20. The apparatus of claim 18,
wherein the at least one processor is further configured to perform operations comprising:
comparing the text-based output comprising the test sequence for validating the DUT to an expected output format;
determining, based on the comparison, whether the text-based output comprising the test sequence for validating the DUT is valid; and
performing, in response to determining that the text-based output comprising the test sequence for validating the DUT is not valid, one or more additional LLM calls to generate the test sequence for validating the DUT based on the generated structured set of test sequence inputs.
